(19) United States
(12) Patent Application Publication
(10) Pub. No.: US 2014/0297502 A1
(43) Pub. Date: Oct. 2, 2014

(54) Defensive Volatility Index Apparatuses, Methods, and Systems

(71) Applicants: Bogdan N. Ianev, New York, NY (US); Ciprian Ticula, New York, NY (US)

(72) Inventors: Bogdan N. Ianev, New York, NY (US); Ciprian Ticula, New York, NY (US)

(21) Appl. No.: 14/217,186

(22) Filed: Mar. 17, 2014

Related U.S. Application Data
(63) Continuation-in-part of application No. 13/712,963, filed on Dec. 12, 2012.
(60) Provisional application No. 61/569,742, filed on Dec. 12, 2011.
(60) Provisional application No. 61/800,711, filed on Mar. 15, 2013.
(60) Provisional application No. 61/947,916, filed on Mar. 4, 2014.

(51) Int. Cl. G06Q 40/04

(52) U.S. Cl. CPC G06Q 40/04
USPC 705/37

(57) ABSTRACT

A rule-based signal-driven algorithmic index and associated financial products for providing downside protection against a volatile index by tracking a long-volatility position placed in the short term or the medium term of an implied volatility curve for a stock index, based on the steepness of the short-term end of the curve versus the steepness of the medium-term end of the curve.

### CROSS REFERENCE TO RELATED APPLICATIONS

This application is a continuation-in-part of U.S. patent application Ser. No. 13/712,963, filed on Dec. 12, 2012, which in turn claims priority to U.S. Provisional Patent Application No. 61/569,742, filed Dec. 12, 2011. The contents of these applications are herein incorporated by reference in their entirety. This application also claims priority to U.S. Provisional Patent Application No. 61/800,711, filed Mar. 15, 2013, and to U.S. Provisional Patent Application No. 61/947,916, filed Mar. 4, 2014. The contents of these applications are also herein incorporated by reference in their entirety.

### FIELD

The present invention is directed generally to methods and systems for creating financial indices and financial instruments. More particularly, the invention is directed to DEFENSIVE VOLATILITY INDEX APPARATUSES, METHODS, AND SYSTEMS (hereinafter DVOL).

### BACKGROUND

Volatility may be used as a measure of financial risk associated with a given financial instrument. For example, the standard deviation of the performance of a given instrument, collection of instruments, or index is one way to measure or define volatility. Like the value of the underlying assets, the volatility may also vary with time and market conditions. There are two types of volatility, one backward looking, and one forward looking. The backward-looking measure of volatility is called realized volatility and is determined by the historical price fluctuations of a given investment. The forward-looking measure of volatility is called implied volatility which may be determined by evaluating a current price of a given investment together with an appropriate pricing model predicting the price of the investment at some time in the future. Instruments that exhibit high volatility may be considered more risky than those with lower volatility.

### BRIEF DESCRIPTION OF THE DRAWINGS

The accompanying drawings illustrate various non-limiting, example, inventive aspects in accordance with the present disclosure:

FIG. 1 shows a schematic illustration of data flows between DVOL components and affiliated entities in one embodiment of DVOL operation;

FIG. 2 shows aspects of DVOL architecture in block-diagram form and data flow between and among DVOL components in one embodiment of DVOL operation;

FIGS. 3A and 3B show an exemplary logic flow in one exemplary embodiment of DVOL operation;

FIGS. 4A and 4B show an exemplary logic flow in another exemplary embodiment of DVOL operation; and

FIG. 5 is a block diagram illustrating embodiments of the DVOL controller.

### DETAILED DESCRIPTION

### DVOL

This disclosure describes defensive volatility index apparatuses, methods, and systems (DVOL) as well as associated financial products. Depending on the particular needs and characteristics of DVOL users and their systems, various embodiments of the DVOL may be implemented that enable a great deal of flexibility and customization.

Implied volatility of an index in many cases may exhibit a negative correlation to the index itself, and as an asset class, is frequently sought after for its tail-hedge properties. Nonetheless, long volatility exposure can incur meaningful negative carry which can significantly erode performance over time. In one implementation, DVOL may be long implied volatility and may use a signal to allocate its positioning either to the short-term or the medium-term maturities of a futures curve, for example, the VIX futures curve, to alleviate the negative carry.

In one exemplary embodiment, the DVOL may be implemented using a signal to determine whether to establish a long position in the S&P 500 VIX Short-Term Futures Index ER (ST Index) or a long position in the S&P 500 VIX Medium-Term Futures Index ER (MT Index).

In one embodiment, the DVOL may be used to create a rule-based signal-driven algorithmic index that seeks to provide downside protection against a volatile index by tracking a long volatility position placed in the short term or the medium term of an implied volatility curve for a stock index.

The DVOL may establish a long position in the short-term or the mid-term portion of an implied volatility curve for a stock index. The position of being long in the short-term portion of the curve may be referred to as “long front” or “front position.” The position of being long the medium-term portion of the curve may be referred to as “long middle” or “middle position.” These pairings may be collectively may be referred to as “positioning.”

The DVOL may decide between tracking a front position or a middle position, and may determine the scale of positioning, based on a signal based on the steepness of the two segments of the curve. The short-term portion of the curve may be represented by a short-term index, and the mid-term portion may be represented by a mid-term index.

In one exemplary embodiment, DVOL may examine the steepness of the two segments of the curve on a daily basis to determine the positioning. In some embodiments, at any time the DVOL may be in one of two positions relative to an implied volatility curve for a stock index: 1) long front or 2) long middle. In some embodiments, the extent to which the DVOL is invested in each position may vary daily according to a signal and a method described below. In some embodiments, the DVOL may also provide exposure at all times to a funded investment in a debt obligation. The size of the allocation may be determined based on a signal, which may be determined by the steepness of a curve or on some other suitable metric. In one embodiment the signal is based on the allocation of the previous day. In some embodiments, the signal may be calculated based on the difference between (1) the difference between two short-term volatility index futures and (2) the difference between two medium-term volatility index futures. As the signal changes, the allocation of the portfolio may gradually change over time.

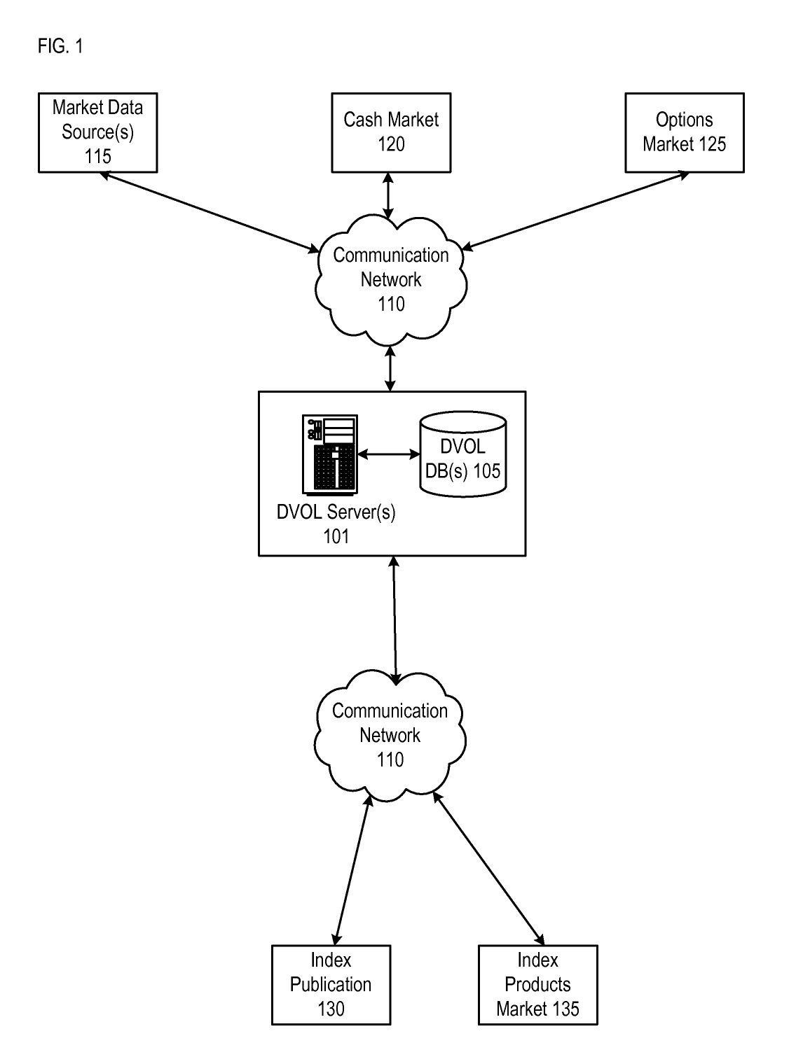

FIG. 1 shows a schematic illustration of data flows between DVOL components and affiliated entities in one embodiment of DVOL operation. The DVOL may, in one implementation, comprise an entity including one or more DVOL servers 101 implementing DVOL functionality and communicatively coupled to one or more DVOL databases (“DBs”) 105 configured to store DVOL data. The DVOL server 101 may be further coupled by a communication network 110 to one or more market data sources 115, such as one or more market data feeds (e.g., Bloomberg's PhatPipe, Dun & Bradstreet, Reuter's Tib, Triarch, and the like) to draw financial data used in the generation and maintenance of DVOL indices. A wide variety of different data may be drawn, such as, but not limited to: current and historical prices of one or more underlying instruments, indices, portfolios, or other assets, current and historical prices for treasury bills, current and historical prices for put and call options on such underlying assets, and the like.

The DVOL may process received market data to generate index values or to determine allocations of funds underlying indices to various investments. In an implementation where the instruments underlying a DVOL index are to be actually obtained, orders for such investments at the determined levels may be placed by the DVOL with one or more cash market 120 or options market 125 exchanges or with other suitable outlets, including one or both of primary and secondary markets. In another implementation, indices may be based on portfolios that are notional, simulated, synthetic, and the like. In such an implementation, orders may still be placed by the DVOL with one or more cash market 120 or options market 125 exchanges or other suitable outlets to generate financial instruments or initiate a transaction involving financial instruments based on DVOL-generated indices.

Index values associated with the portfolio of investments, real or synthetic, that are generated or administered by the DVOL server 101 may be stored in the DVOL database 105 for future retrieval, display, report generation, updating, and the like. In one implementation, the DVOL may further provide index values via a communication network 110 for publication 130, such as to a website, to a market data resource, to a ticker, as a report, and the like. The DVOL may further be configured to generate one or more financial instruments with values linked to the value of one or more DVOL generated indices. Such instruments may include, but are not limited to, equities, debts, derivatives, notes (e.g., structured notes), stocks, preferred shares, bonds, treasuries, debentures, options, futures, swaps, rights, warrants, commodities, currencies, funds, long and short positions, Exchange Traded Funds (ETFs), Exchange Traded Notes (ETNs), insurance and risk transfer agreements, annuities, and other assets or investment interests. DVOL-generated instruments may also be made available for purchase in one or more index products markets 135.

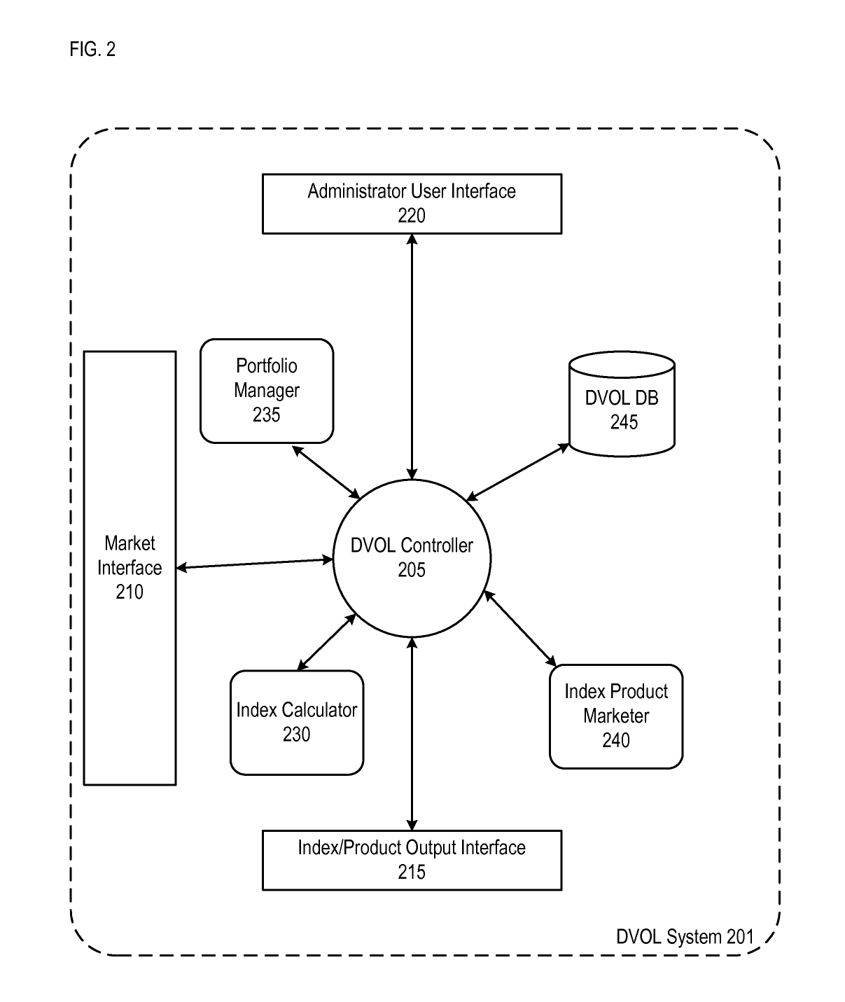

FIG. 2 shows aspects of DVOL architecture in block-diagram form and data flow between and among DVOL components in one embodiment of DVOL operation. A DVOL system 201 may include a number of operational modules and/or data stores configured to carry out DVOL features and/or functionality. A DVOL controller 205 may serve a central role in some embodiments of DVOL operation, serving to orchestrate the reception, generation and distribution of data and/or instructions to, from, and between DVOL modules and to allow further analysis of data generated during DVOL operation. The DVOL controller 205 may be coupled to one or more operational modules configured to implement various features associated with embodiments of DVOL operation.

In one implementation, the DVOL controller 205 may be coupled to a market interface 210 configured to query and/or draw market data from one or more market data sources; place market orders or otherwise effectuate market transactions; receive confirmations of requested instrument transaction fulfillment; and perform other suitable functions.

In one implementation, the DVOL controller 205 may further be coupled to an index/product output interface 215, which may be configured to publish index values; generate or request generation of reports containing index values and/or the values of associated financial products; generate financial products with values linked to DVOL generated index values; provide DVOL financial products for sale on one or more markets or exchanges; and the like. In one implementation, the DVOL controller 205 may further be coupled to an administrator user interface 220 configured to provide an interface through which an administrator can monitor and interact with DVOL system settings and portfolio allocations, manage data, and the like. For example, in one implementation, a DVOL administrator may interface with the DVOL system via the administrator user interface to adjust the values of index calculation or publication times and other parameters associated with the index, as may be needed or desired within a given application of the DVOL.

In one implementation, the DVOL controller 205 may further be coupled to an index calculator module 230 configured to or programmable to calculate official index values. In one implementation, the index value may be calculated on a daily basis, such as at the end of each U.S. trading day.

The index calculator 230 may also be configured to or programmable to track and monitor values of components of one or more underlying real, notional, or simulated DVOL portfolios and to calculate index values based on the value of these components. In one implementation, the index calculator may be configured to calculate the total rate of return of a notional investment in a defensive volatility strategy and a notional cash component resulting from income generated by the initial cash investment and the DVOL strategy. In some embodiments, the index calculator may be configured to calculate the rate of return of the DVOL strategy on an unfunded basis. A portfolio generated by this strategy may include a long/neutral unfunded delta-one position in Short-Term (ST) index units, a long/neutral unfunded delta-one position in Medium Term (MT) index units and may or may not comprises a funded investment in debt obligations.

In one implementation, the DVOL controller 205 may further be coupled to a portfolio manager module 235 configured to manage one or more portfolios of financial instruments underlying one or more DVOL indices. Such portfolios may, in various implementations, comprise actual investments or be notional, simulated or synthetic portfolios with values tied to specified investments. In one implementation, the portfolio manager module may be configured to administer a portfolio underlying the DVOL index comprising positions on a plurality of options on one or more underlying stocks, bonds, debts and/or debentures, currencies, commodities, real properties, options, indices, portfolios, and like assets.

In one implementation, the DVOL controller 205 may further be coupled to an index product marketer module 24o configured to generate, market, manage, and/or the like financial products and/or instruments with values tied to one or more DVOL indices. In various implementations, the index product marketer module may be configured to generate and manage any of a wide variety of different financial products, such as but not limited to: equities, debts, derivatives, notes (e.g., structured notes), stocks, preferred shares, bonds, treasuries, debentures, options, futures, swaps, rights, warrants, commodities, currencies, funds, long and/or short positions, ETFs, ETNs, insurance and/or risk transfer agreements, annuities, and/or other assets or investment interests. In one implementation, the index product marketer module may initiate the formation of a corporation, special purpose entity, fund, and/or the like entity which owns a portfolio underlying a DVOL index and which issues shares with values tied to that index.

In one implementation, the DVOL controller 205 may further be coupled to one or more databases 245 configured to store a variety of data associated with DVOL operation in various embodiments. For example, in one implementation, the DVOL database may include tables for storing information associated with current and/or historical DVOL index values, underlying portfolios and/or portfolio elements, DVOL index linked financial products, market data, transaction orders, transaction histories, and/or the like. Further detail surrounding such tables is provided below.

In one implementation, a DVOL index value may be calculated each day. For example, at the end of each index calculation day, the DVOL portfolio may be rebalanced so that its exposure to a short-term volatility futures index (ST index) and to a medium-term volatility futures index (MT index) is allocated as prescribed by a defensive volatility strategy. A daily rebalancing mechanism may include two components: daily constant proportion rebalancing and signal-based weight adjustments.

Daily constant proportion rebalancing may include adjusting the number of ST index units and the number of MT index units within the DVOL index so that the notional allocation to both the ST index and the MT index is as prescribed by the defensive volatility strategy. Signal-based weight adjustments may be made each day by determining a signal for a given date, which may dictate the target weights for both the ST index and the MT index portions of the DVOL index for the end of the following business day. If any scheduled index calculation day is disrupted, the index calculation day may be adjusted to be the immediately following index calculation day that is not a disrupted day.

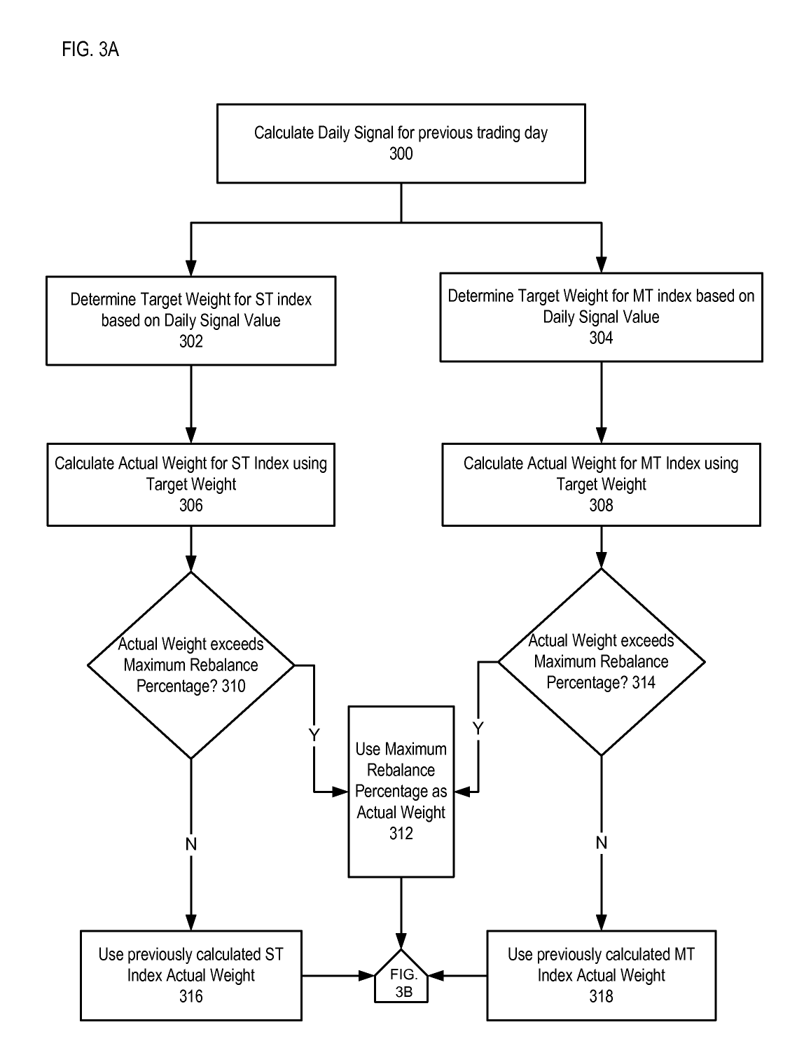

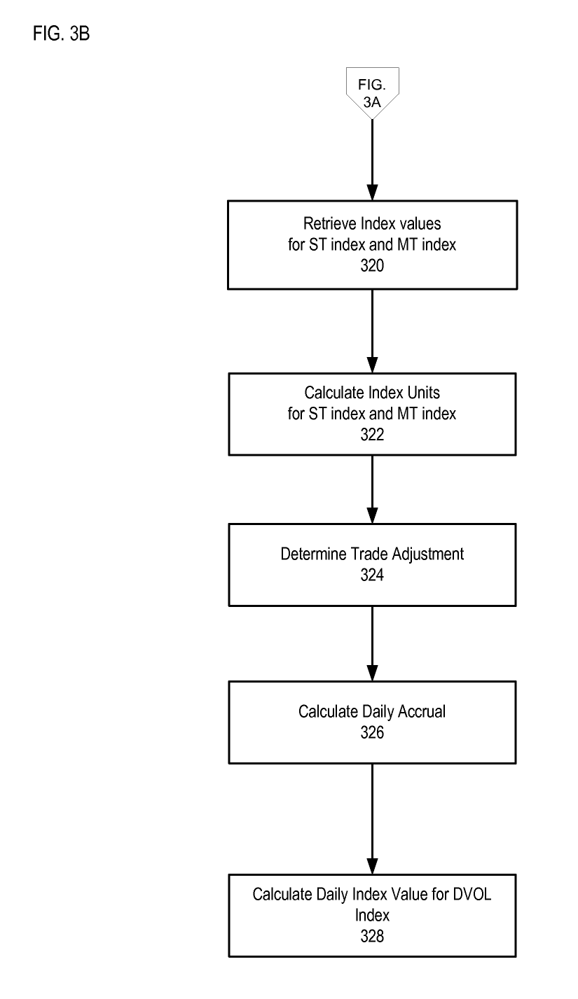

FIGS. 3A and 3B illustrate a logic flow of an exemplary embodiment of a process for calculating the daily value of a DVOL index. As shown in FIG. 3A, at 300, a daily signal is calculated based on market information from the previous trading day. At the end of each index calculation day, this signal may be calculated to determine the allocation to an ST index and an MT index, which may in turn be used to calculate a daily value for the DVOL index at the close of the following index calculation day. In one exemplary embodiment, the signal for the index calculation day may be calculated using the following formula:

Signalₜ=ST_Slopeₜ−MT_Slopeₜ

### Where

“ST_Slopeₜ” (front end of the curve) represents the steepness of the short-term futures curve as measured by the difference between the 2^{nd} and the 1^{st} futures and is calculated as:

ST_Slopeₜ=UX2ₜ−UX1ₜ
“MT_Slopeₜ” (back end of the curve) represents the steepness of the medium-term futures curve as measured by the difference between the 7^{th} and the 4^{th} futures and is calculated as:

MT_Slopeₜ=UX7ₜ−UX4ₜ
“UX1ₜ” is the closing level of the 1^{st} Generic ‘UX’ Future on Index Calculation Day, t (UX1 Index)
   “UX2ₜ” is the closing level of the 2^{nd} Generic ‘UX’ Future on Index Calculation Day, t (UX2 Index)
   “UX4ₜ” is the closing level of the 4^{th} Generic ‘UX’ Future on Index Calculation Day, t (UX4 Index)
   “UX7ₜ” is the closing level of the 7^{th} Generic ‘UX’ Future on Index Calculation Day, t (UX7 Index)

The signal may be calculated daily and may be based on the values of the first, second, fourth, and seventh active volatility futures contracts on the calculation day. The generic ‘UX’ future above represents a future in a volatility index. In one example, the volatility index may be the Volatility Index (VIX) maintained by the Chicago Board Options Exchange (CBOE). A shown in FIG. 3A, at the end of each index calculation day, target weights may be determined for both the ST index portion 302, and the MT index portion 304, of the DVOL index. The level of the signal as of the previous Index Calculation Day may drive the exposure to the ST index and the MT index for the DVOL index. Table 1 below shows an exemplary embodiment of target weight ranges for both the ST index portion and the MT index portions of the DVOL index as of the close of a given index business day (t), which depends on the value for the signal calculated on the previous index calculation day(t−1):

TABLE 1

| Signalₜ₋₁ | ST_Targetₜ | MT_Targetₜ |
|---|---|---|
| (−inf, −1) | 40% | 0% |
| [−1, 0) | 20% | 0% |
| [0, 1) | 5% | 0% |
| [1, inf) | 0% | 5% |

Table 1 is an example of suitable target weights, however, any other suitable target weights may also be used. Using the target weights shown in Table 1 as an example, if the value of the one-month volatility future UX1 were equal to 20.0, the value of the two-month volatility future UX2 were equal to 23.25, the value of the four-month volatility future UX4 were equal to 23.95, and the value of the seventh-month volatility future UX7 were equal to 250.0, the front-end slope of the volatility curve (ST_Slope) would be equal to 30.25 (UX2−UX1) and the back-end slope of the volatility curve (MT_Slope) would be equal to 1.05 (UX7-UX4). The signal would then be equal to 2.2 (ST_Slope−MT_Slope). Using the target values from Table 1, a signal value of 2.2 would correspond to an ST_Target value of o % and an MT_Target value of 5%, since 2.2 is within the range of [1, inf). In other words, the calculated signal would indicate that a neutral position should be taken in the ST index and a long position should be taken in the MT index.

In some embodiments, to prevent excessive rebalancing changes to the actual allocations from one target weight to another may be executed gradually over several index calculation days; the weight change occurring on any index calculation day may not exceed a predetermined maximum rebalance percentage. In one exemplary embodiment, the maximum rebalance percentage may be expressed in basis points (bps). For example the maximum rebalance percentage may be 500 bps, or any other suitable value.

As illustrated in FIG. 3A, the actual weights for the ST index and the MT index may be calculated at 306 and 308, respectively. In one exemplary embodiment, the actual weights for the ST index and the MT index portions of the DVOL index as of any index calculation day may represent the actual allocation to the reference assets as of the close of that day and may be calculated as shown below:

ST_Weightₜ=ST_Weightₜ₋₁+Min{MRP,Abs{ST_Targetₜ−ST_Weightₜ₋₁}}*Sign{ST_Targetₜ−ST_Weightₜ₋₁}

MT_Weightₜ=MT_Weightₜ₋₁+Min{MRP,Abs{MT_Targetₜ−MT_Weightₜ₋₁}}*Sign{MT_Targetₜ−MT_Weightₜ₋₁}

### Where

“t−1” is the Index Calculation Day preceding the Index Calculation Day t
“MRP” is the Maximum Rebalance Percentage
“ST_Targetₜ” is the Target Weight applicable to the ST_Index on Index Calculation Day t
“MT_Targetₜ” is the Target Weight applicable to the MT_Index on Index Calculation Day t
“Sign(x)” is the sign mathematical function, which returns the sign of any real number and is equal to +1 if x is positive and −1 if x is negative.

As shown in FIG. 3A at 310, if the actual weight calculated for the ST index exceeds the maximum rebalance percentage, the maximum rebalance percentage is used as the value for the actual weight, 312. Similarly, at 314, if the actual weight calculated for the MT index is greater than the maximum rebalance percentage, the maximum rebalance percentage is used as the value of the actual weight, 312. In one embodiment, the maximum rebalance percentage may have the same value for both the MT index and the ST index; in another embodiment, there may be two maximum rebalance percentages, one for the ST index portion and one for the MT index portion.

However, if the actual weight calculated for the ST index does not exceed the maximum rebalance percentage, the previously calculated actual index weight for the ST index may be used in the calculation of the DVOL index, as shown at 316. Similarly, if the actual weight calculated for the MT index does not exceed the maximum rebalance percentage, the previously calculated actual index weight for the MT index will be used in the calculation of the DVOL index, as shown at 318 in FIG. 3A.

As shown in FIG. 3B at 320, the index values for the ST index and for the MT index as of the close of the calculation day may be retrieved from any suitable market data feed. As of the close of any index calculation day, the allocation across ST index and MT index may be rebalanced to conform to the prescribed actual weights. In one exemplary embodiment, the corresponding number of index units to be used when calculating the value for the DVOL index may be calculated, as shown at 322 in FIG. 3B, as follows:

$${n}_{t}^{ST\_Index} = \frac{{Index}_{t}}{{ST\_Index}_{t}} * {ST\_Weight}_{t}$$

$${n}_{t}^{M T\_Index} = \frac{{Index}_{t}}{{MT\_Index}_{t}} * {MT\_Weight}_{t}$$

### Where

“Indexₜ” is the Index Value as of the close of the Index Calculation Day, t;
“ST_Weightₜ” is the actual weight applicable to ST_Index for Index Calculation Day, t;
“MT_Weightₜ” is the actual weight applicable to MT_Index for Index Calculation Day, t;

As shown in FIG. 3B at 324, The DVOL index value may also be adjusted for the estimated notional transaction costs incurred as result of rebalancing the notional portfolio. In some embodiments, a notional trading adjustment may vary the level of the DVOL index by (A) a first fraction of the notional amount of the change in the ST_index and (B) a second fraction of the notional amount of the change in the MT index. For example, in some embodiments, the first fraction may be ten basis points and the second fraction may be twenty basis points. On an index calculation day t, such a trading adjustment (TAₜ) may be calculated by index calculator 230. Index calculator 230 may, in one embodiment, use the following formula to calculate (TAₜ):

TAₜ=TA_STₜ+TA_MTₜ

### Where

“TA_STₜ” is the Trading Adjustment associated with the ST_Index and is calculated as:

TA_STₜ=TA_ST_Pct*Abs{ST_Indexₜ*nₜ^{ST}^{_{—}}^{Index}−ST_Index^{t-1}*nₜ₋₁^{ST}^{_{—}}^{Index}}

“TA_MTₜ” is the Trading Adjustment associated with the MT_Index and is calculated as:

TA_MTₜ=TA_MT_Pct*Abs{MT_Indexₜ*nₜ^{MT}^{_{—}}^{Index}−MT_Indexₜ₋₁*nₜ₋₁^{MT}^{_{—}}^{Index}}

“TA_ST_Pct” is the Trading Adjustment applicable to ST_Index and is equal to a predetermined percentage, for example, 0,1%
“TA_MT_Pct” is the Trading Adjustment applicable to MT_Index and is equal to a predetermined percentage, for example, 0.2%

In one exemplary embodiment, as shown at 328 in FIG. 3B, a daily accrual (“DA”) may be calculated, or its value may be set to o. The daily accrual may represent the rate of interest that may be earned on a notional capital reinvestment in a debt obligation. For example, in some embodiments, the debt obligation rate of interest may be that of the three month U.S. Treasury rate as reported, for example, on Bloomberg under ticker USB3MTA. In some embodiments, the daily accrual may be calculated using the following formula:

$${DA}_{t} = {( \frac{1}{1 {TBills}_{t} * \frac{91}{360}} )}^{\frac{{d}_{t}}{91}} - 1$$

### Where:

“TBillsₜ”, for any Index Calculation Day, t, may be, for example, the 3-month T-Bill rate reported by Bloomberg or the like, or its successor (the
   “USB3MTA Index”) on such Index Calculation Day, t; provided that if no number is published for the USB3MTA Index rate by Bloomberg, or if the most recent such rate reported by Bloomberg is more than three (3) weeks old, then “TBillsₜ” may be the rate reported by the United States Treasury Department on its official website as the “Investment Rate” under “Auction Results” for 13-week Bills.
   “dₜ” is the number of calendar days from and excluding the current Index Calculation Date, t, until and including the following Index Calculation Day, t+1

As shown in FIG. 3B, at 328, the daily index value for the DVOL index may be calculated using the index value from the previous trading day, the calculated index units for both the ST index and the MT index, the retrieved index values for both the ST index and the MT index on the previous trading day and the current trading day, the calculated daily accrual, if determined, and the calculated trade adjustment.

For example, the daily value of a DVOL index may be calculated using the following formula:

Indexₜ=Indexₜ₋₁+nₜ₋₁^{ST}^{_{—}}^{Index}*[ST_Indexₜ−ST_Indexₜ₋₁]+nₜ₋₁^{MT}^{_{—}}^{Index}*[MT_Indexₜ−MT_Indexₜ₋₁]−Fee_Mgmtₜ₋₁−TAₜ₋₁

### Where

“t−1” is the Index Calculation Day preceding the Index Calculation Day t;
“Indexₜ₋₁” is the value of the index as of the close of the previous Index Calculation Day, t−1;
   “nₜ₋₁^{ST}^{_{—}}^{Index}” and “nₜ₋₁^{MT}^{_{—}}^{Index}” refer to the number of units held in ST_Index and MT_Index, respectively, as of the end of the previous Index Calculation Day t;
   “ST_Indexₜ” and “MT_Indexₜ”, respectively, denote the values of ST_Index and the MT_Index as of the close of Index Calculation Day t;
   “TAₜ₋₁” denotes a liquidity Trading Adjustments; and
   “DAₜ₋₁” denotes the Daily Accrual as defined above.

In one exemplary embodiment, index product marketer 240 may be configured to create and manage one or more exchange-traded volatility products based on the calculated DVOL index values. In one exemplary embodiment, the ST index is the S&P 500 Short-Term Futures index (SPVXSP), which tracks a portfolio of the front two VIX futures, which is rolled each day from the 2nd VIX future to the 1st VIX future for a one-month constant maturity exposure. The VIX is a volatility index published by the Chicago Board Options Exchange (CBOE) that measures implied volatility of the S&P 500 stock market index. In one exemplary embodiment, the MT index is the S&P 500 Medium-Term Futures index (SPVXMP), which tracks a portfolio of the 4th to 7th VIX futures, which is rolled each day from the 7th VIX future to the 4th.

In one exemplary embodiment, the exchange-traded volatility products based on the DVOL index values may provide downside protection against a volatile index by calculating the steepness in the short end of the VIX futures curve against the steepness of the medium-term range of the VIX futures curve. This may be done by calculating a signal based on the current state of the curve and appropriately capturing the value of the roll in the front end versus the roll in the back end of the curve.

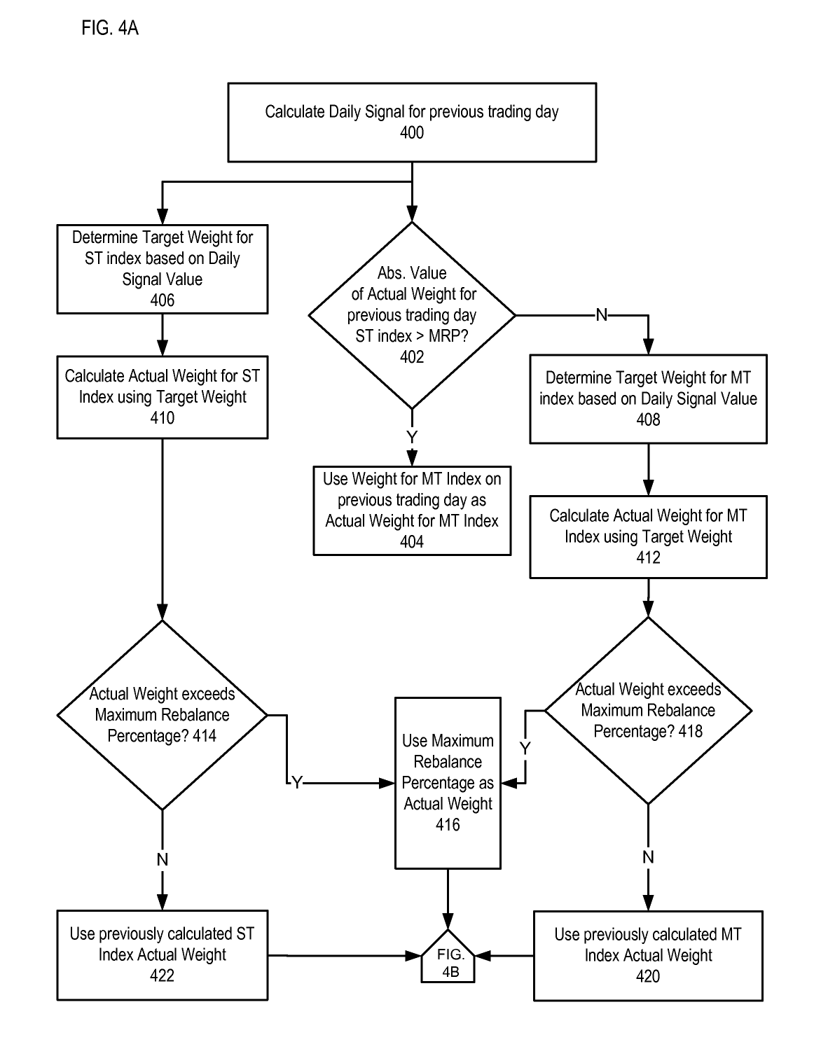

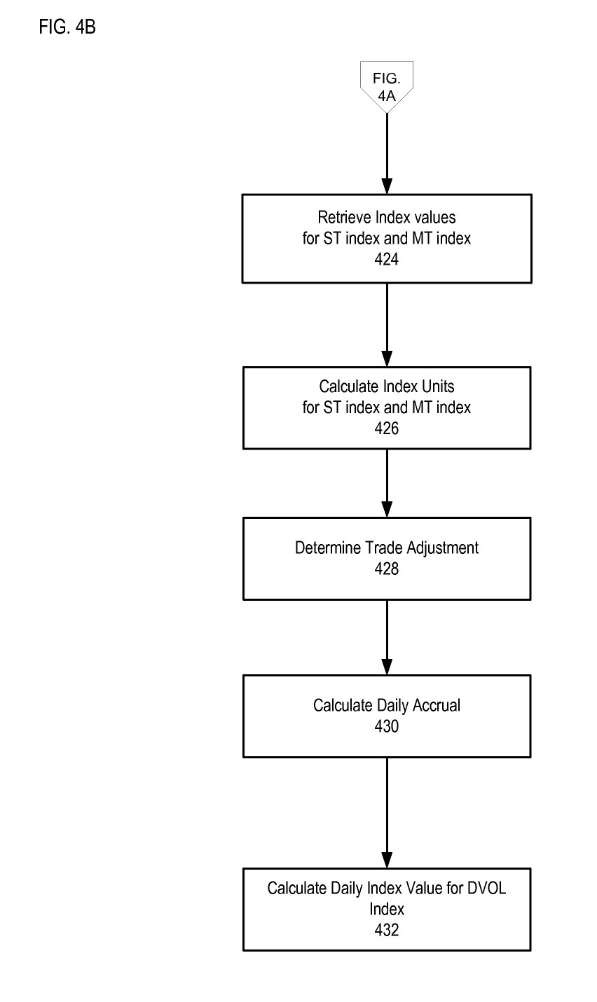

FIGS. 4A and 4B illustrate a logic flow of another exemplary embodiment of a process for calculating the daily value of a DVOL index. As shown in FIG. 4A, at 400, a daily signal may be calculated based on market information from the previous trading day. At the end of each index calculation day, this signal may be calculated to determine the allocation to an ST index and an MT index, which will in turn be used to calculate a daily value for the DVOL index at the close of the following index calculation day. The signal may be calculated based on the expected decay of a long position in each of a short-term portion and a long-term portion of a volatility index (such as the VIX, for example) futures curve. For example, the signal may be calculated based on the difference between (i) expected decay of the constant maturity position in the front of the curve from the following day to the day following that one and (2) expected decay of the constant maturity position in the middle end of the curve from the following day to the day following that one. As the signal changes over time, the allocation of the portfolio may change. One exemplary embodiment that calculates the value of the index based on the expected decay in the futures curve is disclosed below. In this embodiment, the signal may be calculated using the following formula:

Signalₜ=ST_Decayₜ−MT_Decayₜ

### Where

“ST_Decayₜ” represents the projected decay or carry of the ST_Index from the scheduled Index Calculation Day t+1 to the scheduled Index Calculation Date t+2 as projected at the end of the Index Calculation Day t by assuming that from days t to t+1 and t+2 the futures curve remains unchanged (i.e. all futures roll down the curve perfectly). In one exemplary embodiment,
“ST_Decayₜ” may be calculated as follows:

$${ST\_Decay}_{t} = - ( \frac{{ST\_Projection}_{t , t + 2}}{{ST\_Projection}_{t , t + 1}} - 1 )$$

“MT_Decayₜ” represents the projected decay or carry of the MT_Index from the scheduled Index Calculation Day t+1 to the scheduled Index Calculation Date t+2 as projected at the end of the Index Calculation Day t by assuming that from days t to t+1 and t+2 the futures curve remains unchanged (i.e. all futures roll down the curve perfectly). In one exemplary embodiment, “MT_Decayₜ” may be calculated as follows:

$${MT\_Decay}_{t} = - ( \frac{{MT\_Projection}_{t , t + 2}}{{MT\_Projection}_{t , t + 1}} - 1 )$$

In one exemplary embodiment, the projected decay of the MT index and the projected decay of the ST index used to calculate the signal may be calculated using a short-term index projection and a medium-term index projection that in turn incorporate a calculation of futures for a volatility index (such as the VIX), price projection, and an interpolation factor.

For example, the short-term index projection with respect to an index calculation day t, and a number of index calculation days m may represent the projected value of ST_Index as of the end of day t for the value at the end of the day, which is m scheduled index calculation days (for example, m=1 or 2) after the day t. Such value may be calculated, for example, using the projected VIX futures composition of ST_Index on such index calculation day t+m as well as the projected future value for the underlying VIX futures in the composition of ST_Index assuming all futures roll perfectly down the curve and the curve remains unchanged. In one exemplary embodiment, the short-term index projection for any calculation day t may be calculated using the following formulas:

$${ST\_Projection}_{t , t + 1} = {ST\_Index}_{t} \times \frac{{\sum }_{n = 1}^{2} {w ( n )}_{t} \times {UXn}_{t , t + 1}}{{\sum }_{n = 1}^{2} {w ( n )}_{t} \times {UXn}_{t}}$$

$${ST\_Projection}_{t , t + 2} = \{ \begin{matrix}\begin{matrix}{ST\_Projection}_{t , t + 1} \times \frac{{\sum }_{n = 1}^{2} {w ( n )}_{t + 1} \times {UXn}_{t , t + 2}}{{\sum }_{n = 1}^{2} {w ( n )}_{t + 1} \times {UXn}_{t , t + 1}} , \\ if t is not a Futures Roll Date\end{matrix} \\ \begin{matrix}{ST\_Projection}_{t , t + 1} \times \frac{{\sum }_{n = 1}^{2} {w ( n )}_{t + 1} \times {UX ( n + 1 )}_{t , t + 2}}{{\sum }_{n = 1}^{2} {w ( n )}_{t + 1} \times {UX ( n + 1 )}_{t , t + 1}} , \\ if t is a Futures Roll Date\end{matrix}\end{matrix}$$

### Where:

“t+m” is the Index Calculation Day, which is m scheduled

Index Calculation Days immediately following the current Index Calculation Day, t;
“w(n)ₜ”, “w(n)ₜ₊ₘ” is the ST Contract Roll Weight that on date t or t+m, respectively, would apply to the relevant futures contract as per the formula above and may be determined as:

$${w ( 1 )}_{t + m} = 100 \times \frac{{DaysRemaining}_{t + m}}{{DaysTotal}_{t + m}}$$

$${w ( 2 )}_{t + m} = 100 \times ( 1 - \frac{{DaysRemaining}_{t + m}}{{DaysTotal}_{t + m}} )$$

Where:
“DaysTotalₜ₊ₘ” is the total number of business days from (and including) the most recent futures index Settlement Date, which falls on t+m or precedes it, to (and excluding) the next volatility index Futures Settlement Date. The number of business days may stay constant in cases where a new holiday is introduced intra-month or where there is an unscheduled market closure.
“DaysRemainingₜ₊ₘ” is the total number of business days from (and including) the business day following t+m to (and excluding) the first volatility index Futures Settlement Date, which falls on t+m or succeeds it. The number of business days includes a new holiday introduced intra-month up to the business day preceding such a holiday.
“UXnₜ” is the official closing price of the futures contract UXnₜ as of the close of the Index Calculation Day t;
“UXn_{t,t+m}” is the futures index Price Projection for the price of the futures contract UXnₜ for the close of the Index Calculation Day t+m as of the Index Calculation Date t;

In one exemplary embodiment, the medium-term index Projection (“MT_Projection_{t,t+m}”) with respect to an index calculation day t and a number of days m (for example, m=1 or 2) may represent the projected value of MT_Index as of the end of day t for the value at the end of the day, which is m scheduled index calculation days after the day t. Such value may be calculated using the projected volatility index (such as the VIX) futures composition of MT_Index on such index calculation day t+m as well as the projected future value for the underlying volatility index futures in the composition of MT_Index assuming all futures roll perfectly down the curve and the curve remains unchanged. In one exemplary embodiment, the medium-term index projection for any calculation day t may be calculated using the following formulas:

$${MT\_Projection}_{t , t + 1} = {MT\_Index}_{t} \times \frac{{\sum }_{n = 4}^{7} {w ( n )}_{t} \times {UXn}_{t , t + 1}}{{\sum }_{n = 4}^{7} {w ( n )}_{t} \times {UXn}_{t}}$$

$${MT\_Projection}_{t , t + 2} = \{ \begin{matrix}\begin{matrix}{MT\_Projection}_{t , t + 1} \times \frac{{\sum }_{n = 4}^{7} {w ( n )}_{t + 1} \times {UXn}_{t , t + 2}}{{\sum }_{n = 4}^{7} {w ( n )}_{t + 1} \times {UXn}_{t , t + 1}} , \\ if t is not a Futures Roll Date\end{matrix} \\ \begin{matrix}{MT\_Projection}_{t , t + 1} \times \frac{{\sum }_{n = 4}^{7} {w ( n )}_{t + 1} \times {UX ( n + 1 )}_{t , t + 2}}{{\sum }_{n = 4}^{7} {w ( n )}_{t + 1} \times {UX ( n + 1 )}_{t , t + 1}} , \\ if t is a Futures Roll Date\end{matrix}\end{matrix}$$

### Where:

“t+m” is the Index Calculation Day, which is m scheduled Index Calculation Days immediately following the current Index Calculation Day, t;
“t+m” is the Index Calculation Day, which is m scheduled Index Calculation Days immediately following the current Index Calculation Day, t;
“w(n)ₜ” or “w(n)ₜ₊ₘ” is the MT Contract Roll Weight that on date t or t+m, respectively, would apply to the relevant futures contract as per the formula above and may be determined as:

$${w ( 4 )}_{t + m} = 100 \times \frac{{DaysRemaining}_{t + m}}{{DaysTotal}_{t + m}}$$

$${w ( 5 )}_{t + m} = 100$$

$${w ( 6 )}_{t + m} = 100$$

$${w ( 7 )}_{t + m} = 100 \times ( 1 - \frac{{DaysRemaining}_{t + m}}{{DaysTotal}_{t + m}} )$$

where
“DaysTotalₜ₊ₘ” is the total number of business days from (and including) the most recent volatility index Futures Settlement Date, which falls on t+m or precedes it, to (and excluding) the next volatility index Futures Settlement Date. The number of business days stays constant in cases of a new holiday introduced intra-month or an unscheduled market closure.
“DaysRemainingₜ₊ₘ” is the total number of business days from (and including) the business day following t+m to (and excluding) the first volatility index Futures Settlement Date, which falls on t+m or succeeds it. The number of business days includes a new holiday introduced intra-month up to the business day preceding such a holiday.
“UXnₜ” is the official closing price of the futures contract UXnₜ as of the close of the Index Calculation Day t;
“UXn_{t,t+m}” is the volatility index Futures Price Projection for the price of the futures contract UXnₜ for the close of the Index Calculation Day t+m as of the Index Calculation date t

The volatility index futures price projection (annotated with second subscript shown in the formulas above as “UXn_{t,t+m}”) with respect to an index calculation day t and a number of index calculation days m (for example), m=1 or 2) may represent the projected value of the volatility index future contract UXnₜ as of the day of day t, for the date which is m scheduled index calculation days following the day t. A value for this futures prices projection may be computed on the day t assuming that all futures roll perfectly down the curve, and the volatility index futures curve remains the same over the next m index calculation days. In one exemplary embodiment, the volatility index futures price projection for any calculation day may be calculated using the following formulas:

$${UXn}_{t , t + 1} = {InterpFactor ( n )}_{t , t + 1} \times {UX ( n - 1 )}_{t} + ( 1 - {InterpFactor ( n )}_{t , t + 1} ) \times {UXn}_{t}$$

$${UXn}_{t , t + 2} = \{ \begin{matrix}UX {0}_{t} , if n = 1 , t is a Futures Roll Date \\ \begin{matrix}{InterpFactor ( 2 )}_{t , t + 2} \times {UX ( 0 )}_{t} + ( 1 - {InterpFactort ( 2 )}_{t , t + 2} ) \times {UX ( 2 )}_{t} , \\ if n = 2 , t is a Futures Roll Date\end{matrix} \\ \begin{matrix}{InterpFactor ( n )}_{t , t + 2} \times {UX ( n - 1 )}_{t} + ( 1 - {InterpFactort ( n )}_{t , t + 2} ) \times {UXn}_{t} , \\ otherwise\end{matrix}\end{matrix}$$

### Where:

“t+m” is the Index Calculation Day, which is m scheduled Index Calculation Days immediately following the current Index Calculation Day, t;
“InterpFactor(n)_{t,t+}m” is the Interpolation Factor as described below

The interpolation factor (“InterpFactor(n)_{t,t+m}” in the formulas above) with respect to an index calculation day t number of index calculation days m (for example, m=1 or 2), and a volatility index future price projection (UXn_{t,t+m}) may be the weight used to interpolate between two relevant futures contracts, to approximate the value of that future m index calculations days after day t. In one exemplary embodiment, the interpolation factor may be calculated using the following formulas:

$${InterpFactor ( n )}_{t , t + 1} = \frac{{NumberOfDays}_{t , t + 1}}{{DaysToExpiry ( n )}_{t} - {DaysToExpiry ( n - 1 )}_{t}}$$

$${InterpFactor ( n )}_{t , t + 2} = \frac{{NumberOfDays}_{t , t + 2}}{{DaysToExpiry ( n )}_{t} - {DaysToExpiry ( n - 1 )}_{t}}$$

### Where:

“t+m” is the Index Calculation Day, which is m scheduled Index Calculation Days immediately following the current Index Calculation Day, t;
“Number of Days_{t,t+m}” is the number of calendar days from (and including) the current Index Calculation Day, t, to (and excluding) the m-th scheduled Index Calculation Day immediately following t;
“DaysToExpiry(n)ₜ” is the number of calendar days from (and including) the current Index Calculation Day, t, to (and excluding) the Final Settlement Date of the future UXnₜ; provided that, DaysToExpiry(o)ₜ=o.

The signal may be calculated daily and may be based on the values of the first, second, fourth, and seventh active volatility futures contracts on the calculation day. As shown in FIG. 4A, at the end of each index calculation day, target weights may be determined for both the ST index portion and the MT index portion of the DVOL index. The level of the signal as of the previous index calculation day may drive the exposure to the ST index and the MT index for the DVOL index. Table 2 below shows an exemplary embodiment of target weight ranges for both the ST index portion and the MT index portions of the DVOL index as of the close of a given index business day (t), which depends on the value for the signal calculated on the previous index calculation day(t−1):

TABLE 2

| Signalₜ₋₁ | ST_Targetₜ | MT_Targetₜ |
|---|---|---|
| (−inf, −.0015) | 40% | 0% |
| [−.0015, −0.0005) | 20% | 0% |
| [−0.0005, 0) | 5% | 0% |
| [0, inf) | 0% | 5% |

In some embodiments, to prevent excessive rebalancing changes to the actual allocations from one target weight to another may be executed gradually over several index calculation days; the weight change occurring on any index calculation day may not exceed a predetermined maximum rebalance percentage.

As illustrated in FIG. 4A, the actual weights for the ST index and the MT index may be calculated by first determining at 402 whether the absolute value of the actual weight of the ST index for the previous trading day is greater than a predetermined maximum rebalance percentage (MRP). If the absolute value of the actual weight of the ST index for the previous trading day is greater than the maximum rebalance percentage, as shown at 404, the actual weight used for the MT index is equal to the actual weight of the MT index for the previous trading day. If the absolute value of the actual weight of the ST index for the previous trading day is not greater than the maximum rebalance percentage, the actual weight for the MT index may be calculated as shown beginning at 408 of FIG. 4A by determining a target weight for the MT index based on the daily signal value, and then calculating the actual weight for the MT_Index using the previously calculated target weight, as shown at 412. The actual weight of the ST index may be calculated as shown beginning at 406 of FIG. 4A by determining a target weight for the ST index based on the daily signal value, and then calculating the actual weight for the ST Index suing the previously calculated target weight, as shown at 410. In one exemplary embodiment, the actual weights for the ST index and the MT index portions of the DVOL index as of any index calculation day may represent the actual allocation to the reference assets as of the close of that day and may be calculated as shown below:

If abs(ST_Weightₜ₋₁)>maximum rebalance percentage (MRP), then

ST_Weightₜ=ST_Weightₜ₋₁+Min{MRP,Abs{ST_Targetₜ−ST_Weightₜ₋₁}}*Sign{ST_Targetₜ−ST_Weightₜ₋₄}

MT_Weightₜ=MT_Weightₜ₋₁

Otherwise,

ST_Weightₜ=ST_Weightₜ₋₁+Min{MRP,Abs{ST_Targetₜ−ST_Weightₜ₋₁}}*Sign{ST_Targetₜ−ST_Weightₜ₋₁}

MT_Weightₜ=MT_Weightₜ₋₁+Min{MRP,Abs{MT_Targetₜ−MT_Weightₜ₋₁}}*Sign{MT_Targetₜ−MT_Weightₜ₋₁}

### Where

“t−1” is the Index Calculation Day preceding the Index Calculation Day t “MRP” is the Maximum Rebalance Percentage
“ST_Targetₜ” is the Target Weight applicable to the ST_Index on Index Calculation Day t
“MT_Targetₜ” is the Target Weight applicable to the MT_Index on Index Calculation Day t
“Sign(x)” is the sign mathematical function, which returns the sign of any real number and is equal to +1 if x is positive and −1 if x is negative.

As shown in FIG. 4A at 414, if the actual weight calculated for the ST index exceeds the maximum rebalance percentage, the maximum rebalance percentage is used as the value for the actual weight, 416. Similarly, at 412, if the actual weight calculated for the MT index is greater than the maximum rebalance percentage, 418, the maximum rebalance percentage is used as the value of the actual weight, 416. In one embodiment, the maximum rebalance percentage may have the same value for both the MT index and the ST index; in another embodiment, there may be two maximum rebalance percentages, one for the ST index portion and one for the MT index portion.

However, if the actual weight calculated for the ST index does not exceed the maximum rebalance percentage, the previously calculated actual index weight for the ST index will be used in the calculation of the DVOL index, as shown at 422. Similarly, if the actual weight calculated for the MT index does not exceed the maximum rebalance percentage, the previously calculated actual index weight for the MT index will be used in the calculation of the DVOL index, as shown at 420 in FIG. 4A.

As shown in FIG. 4B at 424, the index values for the ST index and for the MT index as of the close of the calculation day may be retrieved from a suitable market data feed. As of the close of any index calculation day, the allocation across ST index and MT index may be rebalanced to conform to the prescribed actual weights. In one exemplary embodiment, the corresponding number of index units to be used when calculating the value for the DVOL index may be calculated, as shown at 426 in FIG. 4B, as follows:

$${n}_{t}^{ST\_Index} = \frac{{Index}_{t}}{{ST\_Index}_{t}} * {ST\_Weight}_{t}$$

$${n}_{t}^{M T\_Index} = \frac{{Index}_{t}}{{MT\_Index}_{t}} * {MT\_Weight}_{t}$$

### Where:

“Indexₜ” is the Index Value as of the close of the Index Calculation Day, t;
“ST_Weightₜ” is the actual weight applicable to ST_Index for Index Calculation Day, t;
“MT_Weightₜ” is the actual weight applicable to MT_Index for Index Calculation Day, t;

As shown in FIG. 4B at 428, The DVOL index value may also be adjusted for the estimated notional transaction costs incurred as result of rebalancing the notional portfolio. In some embodiments, a notional trading adjustment may vary the level of the Index by (A) a first fraction of the notional amount of the change in the ST index and (B) a second fraction of the notional amount of the change in the MT index. For example, in some embodiments, the first fraction may be ten basis points and the second fraction may be twenty basis points. On an index calculation day t, such a trading adjustment (TAₜ) may be calculated by an index calculator 230. Index calculator 230, in one embodiment, may use the following formula to calculate (TAₜ):

TAₜ=TA_STₜ+TA_MTₜ

### Where:

“TA_STₜ” is the Trading Adjustment associated with the ST_Index and is calculated as:

TA_STₜ=TA_ST_Pct*Abs{ST_Indexₜ*n^{ST}^{_{—}}^{Index}−ST_Indexₜ₋₁*nₜ₋₁^{ST}^{_{—}}^{Index}}
“TA_MTₜ” is the Trading Adjustment associated with the MT_Index and is calculated as:

TA_MTₜ=TA_MT_Pct*Abs{MT_Indexₜ*nₜ^{MT}^{_{—}}^{Index}−MT_Indexₜ₋₁*nₜ₋₁^{MT}^{_{—}}^{Index}}
“TA_ST_Pct” is the Trading Adjustment applicable to ST_Index and is equal to a predetermined percentage, for example, 0.1% “TA_MT_Pct” is the Trading Adjustment applicable to MT_Index and is equal to a predetermined percentage, for example, 0.2%

In one exemplary embodiment, as shown at 430 in FIG. 4B, a daily accrual (“DA”) may be calculated, or its value may be set to 0. The daily accrual may represent the rate of interest that may be earned on a notional capital reinvestment in a debt obligation. For example, in some embodiments, the debt obligation rate of interest may be that of the three month U.S. Treasury rate as reported, for example, on Bloomberg under ticker USB3MTA. In some embodiments, the daily accrual may be calculated using the following formula:

$${DA}_{t} = {( \frac{1}{1 {TBills}_{t} * \frac{91}{360}} )}^{\frac{{d}_{t}}{91}} - 1$$

### Where:

“TBillsₜ”, for any Index Calculation Day, t, may be, for example, the 3-month T-Bill rate reported by Bloomberg or the like, or its successor (the “USB3MTA Index”) on such Index Calculation Day, t; provided that if no number is published for the USB3MTA Index rate by Bloomberg, or if the most recent such rate reported by Bloomberg is more than three (3) weeks old, then “TBillsₜ” may be the rate reported by the United States Treasury Department on its official website as the “Investment Rate” under “Auction Results” for 13-week Bills.
“dₜ” is the number of calendar days from and excluding the current Index Calculation Date, t, until and including the following Index Calculation Day, t+1

To control against adverse movements in the DVOL index, a loss control feature triggered by a loss control event may be included as part of the DVOL index. On any given index calculation day, a loss control even may be deemed applicable if realized volatility exceeds a predetermined volume trigger or if the moving average is less than a predetermined moving-average trigger. More details regarding the loss control feature are shown below:

Loss Control Eventₜ is applicable if:

RealizedVolₜ>Vol_Trigger or (1)

MovingAverageₜ<MA_Trigger (2)

### Where:

“Vol_Trigger” predetermined value, for example, 0.40
“MA_Trigger” predetermined value, for example, −0.025
“RealizedVolₜ” in one embodiment, is the 3-day realized volatility of the returns of Index over the 4-day period that is composed of the Index Calculation Day t, and the 3 immediately preceding Index Calculation Days.

$${RealizedVd}_{t} = \sqrt{\frac{252}{3 - 1} {\sum }_{i = t - 2}^{t} {( Ln [ \frac{{Index}_{i}}{{Index}_{i - 1}} ] - \frac{1}{3} {\sum }_{j = t - 2}^{t} Ln [ \frac{{Index}_{j}}{{Index}_{j - 1}} ] )}^{2}}$$

“MovingAverageₜ” in one embodiment, is the 5-day moving average of the returns of Index on the Index Calculation Day t relative to the 5-day period that is composed of the 5 immediately preceding Index Calculation Days.

$${MovingAverage}_{t} = Ln [ {Index}_{t} ] - \frac{1}{5} {\sum }_{i = t - 5}^{t - 1} Ln [ {Index}_{i} ]$$

Should the loss control feature be triggered, the value the signal may default to a predetermined value. For example, in one exemplary embodiment, ST_Target may be equal to 0% and MT_Target may be equal to 5%.

As shown in FIG. 4B, at 432, the daily index value for the DVOL index may be calculated using the index value from the previous trading day, the calculated index units for both the ST index and the MT index, the retrieved index values for both the ST index and the MT index on the previous trading day and the current trading day, the calculated daily accrual, if determined, and the calculated trade adjustment.

For example, the daily value of a DVOL index may be calculated using the following formula:

Indexₜ=Indexₜ₋₁+nₜ₋₁^{ST}^{_{—}}^{Index}*[ST_Indexₜ−ST_Indexₜ₋₁]+nₙ₋₁^{MT}^{_{—}}^{Index}*[MT_Indexₜ−MT_Indexₜ₋₁]−Fee_Mgmtₜ₋₁−TAₜ₋₁

### Where

“t−1” is the Index Calculation Day preceding the Index Calculation Day t;
“Indexₜ₋₁” is the value of the index as of the close of the previous Index Calculation Day, t−1;
“nₜ₋₁^{ST}^{_{—}}^{index}” and “nₜ₋₁^{MT}^{_{—}}^{index}” refer to the number of units held in ST_Index and MT_Index, respectively, as of the end of the previous Index Calculation Day t;
“ST_Index,” and “MT_Indexₜ”, respectively, denote the values of ST_Index and the MT_Index as of the close of Index Calculation Day t;
“TAₜ₋₁” denotes a liquidity Trading Adjustments; and
“DAₜ₋₁” denotes the Daily Accrual as defined above.

### DVOL Controller

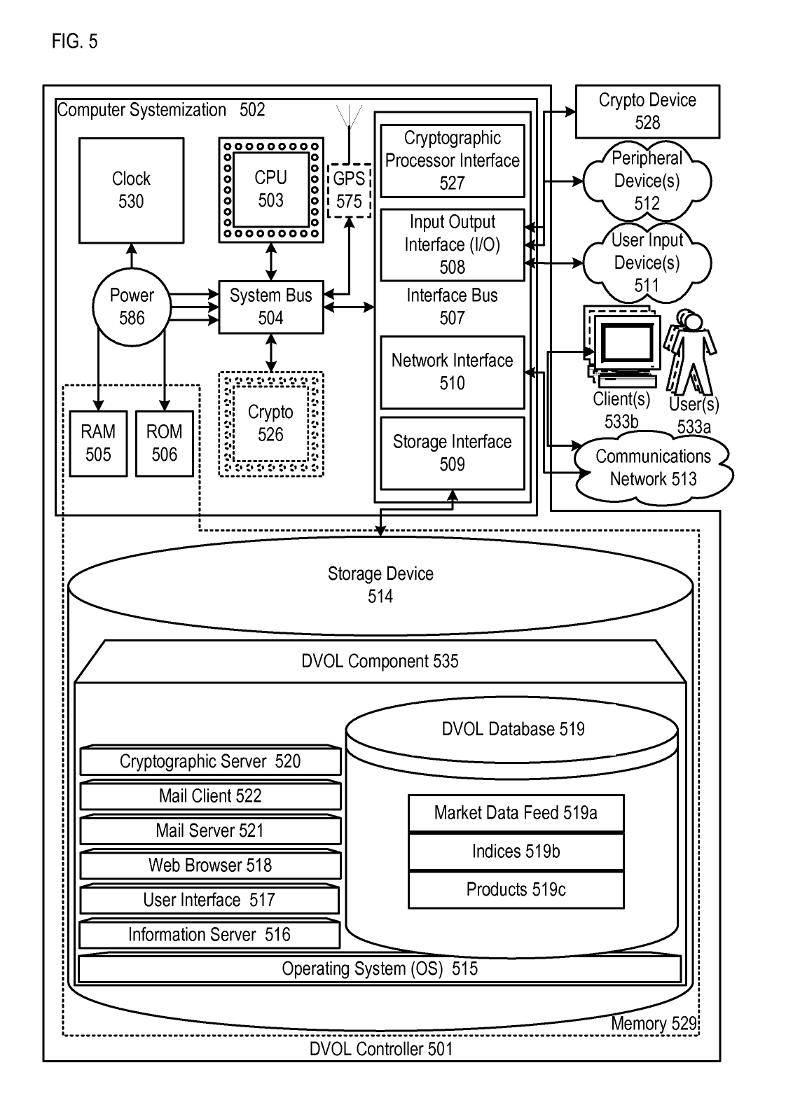

FIG. 5 illustrates inventive aspects of a DVOL controller 501 in a block diagram. In this embodiment, the DVOL controller 501 may serve to aggregate, process, store, search, serve, identify, instruct, generate, match, and/or facilitate interactions with a computer through forward implied variance index and associated financial product generation and management technologies, and/or other related data.

Typically, users, which may be people and/or other systems, may engage information technology systems (e.g., computers) to facilitate information processing. In turn, computers employ processors to process information; such processors 503 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the DVOL controller 501 may be connected to and/or communicate with entities such as, but not limited to: one or more users from user input devices 511; peripheral devices 512; an optional cryptographic processor device 528; and/or a communications network 513.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The DVOL controller 501 may be based on computer systems that may comprise, but are not limited to, components such as: a computer systemization 502 connected to memory 529.

### Computer Systemization

A computer systemization 502 may comprise a clock 530, central processing unit (“CPU(s)” and/or “processor(s)” (these terms are used interchangeable throughout the disclosure unless noted to the contrary))503, a memory 529 (e.g., a read only memory (ROM)506, a random access memory (RAM)505, etc.), and/or an interface bus 507, and most frequently, although not necessarily, are all interconnected and/or communicating through a system bus 504 on one or more (mother)board(s) 502 having conductive and/or otherwise transportive circuit pathways through which instructions (e.g., binary encoded signals) may travel to effect communications, operations, storage, etc. Optionally, the computer systemization may be connected to an internal power source 586. Optionally, a cryptographic processor 526 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the DVOL controller and beyond through various interfaces. Should processing requirements dictate a greater amount speed and/or capacity, distributed processors (e.g., Distributed DVOL), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the DVOL may be achieved by implementing a microcontroller such as CAST's R8051XC2 microcontroller; Intel's MCS 51 (i.e., 8051 microcontroller); and/or the like. Also, to implement certain features of the DVOL, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the DVOL component collection (distributed or otherwise) and/or features may be implemented via the microprocessor and/or via embedded components; e.g., via ASIC, coprocessor, DSP, FPGA, and/or the like. Alternately, some implementations of the DVOL may be implemented with embedded components that are configured and used to achieve a variety of features or signal processing.

Depending on the particular implementation, the embedded components may include software solutions, hardware solutions, and/or some combination of both hardware/software solutions. For example, DVOL features discussed herein may be achieved through implementing FPGAs, which are a semiconductor devices containing programmable logic components called “logic blocks,” and programmable interconnects, such as the high performance FPGA Virtex series and/or the low cost Spartan series manufactured by Xilinx. Logic blocks and interconnects can be programmed by the customer or designer, after the FPGA is manufactured, to implement any of the DVOL features. A hierarchy of programmable interconnects allow logic blocks to be interconnected as needed by the DVOL system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the DVOL may be developed on regular FPGAs and then migrated into a fixed version that more resembles ASIC implementations. Alternate or coordinating implementations may migrate DVOL controller features to a final ASIC instead of or in addition to FPGAs. Depending on the implementation all of the aforementioned embedded components and microprocessors may be considered the “CPU” and/or “processor” for the DVOL.

### Power Source

The power source 586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 586 is connected to at least one of the interconnected subsequent components of the DVOL thereby providing an electric current to all subsequent components. In one example, the power source 586 is connected to the system bus component 504. In an alternative embodiment, an outside power source 586 is provided through a connection across the I/O 508 interface. For example, a USB and/or IEEE 1394 connection carries both data and power across the connection and is therefore a suitable source of power.

### Interface Adapters

Interface bus(ses) 507 may accept, connect, and/or communicate to a number of interface adapters, conventionally although not necessarily in the form of adapter cards, such as but not limited to: input output interfaces (I/O) 508, storage interfaces 509, network interfaces 510, and/or the like. Optionally, cryptographic processor interfaces 527 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 509 may accept, communicate, and/or connect to a number of storage devices such as, but not limited to: storage devices 514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 510 may accept, communicate, and/or connect to a communications network 513. Through a communications network 513, the DVOL controller is accessible through remote clients 533b (e.g., computers with web browsers) by users 533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed DVOL), architectures may similarly be employed to pool, load balance, and/or otherwise increase the communicative bandwidth required by the DVOL controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 510 may be used to engage with various communications network types 513. For example, multiple network interfaces may be employed to allow for the communication over broadcast, multicast, and/or unicast networks.

Input Output interfaces (I/O) 508 may accept, communicate, and/or connect to user input devices 511, peripheral devices 512, cryptographic processor devices 528, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.m/big/nix, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 511 may be card readers, dongles, finger print readers, gloves, graphics tablets, joysticks, keyboards, mouse (mice), remote controls, retina readers, trackballs, trackpads, and/or the like.

Peripheral devices 512 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the DVOL controller may be embodied as an embedded, dedicated, and/or monitor-less (i.e., headless) device, wherein access would be provided over a network interface connection.

Cryptographic units such as, but not limited to, microcontrollers, processors 526, interfaces 527, and/or devices 528 may be attached, and/or communicate with the DVOL controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 529. However, memory is a fungible technology and resource, thus, any number of memory embodiments may be employed in lieu of or in concert with one another. It is to be understood that the DVOL controller and/or a computer systemization may employ various forms of memory 529. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 529 will include ROM 506, RAM 505, and a storage device 514. A storage device 514 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 529 may contain a collection of program and/or database components and/or data such as, but not limited to: operating system component(s) 515 (operating system); information server component(s) 516 (information server); user interface component(s) 517 (user interface); Web browser component(s) 518 (Web browser); database(s) 519; mail server component(s) 521; mail client component(s) 522; cryptographic server component(s) 520 (cryptographic server); the DVOL component(s) 535; and/or the like (i.e., collectively a component collection). These components may be stored and accessed from the storage devices and/or from storage devices accessible through an interface bus. Although non-conventional program components such as those in the component collection, typically, are stored in a local storage device 514, they may also be loaded and/or stored in memory such as: peripheral devices, RAM, remote storage facilities through a communications network, ROM, various forms of memory, and/or the like.

### Operating System

The operating system component 515 is an executable program component facilitating the operation of the DVOL controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the DVOL controller to communicate with other entities through a communications network 513. Various communication protocols may be used by the DVOL controller as a subcarrier transport mechanism for interaction, such as, but not limited to: multicast, TCP/IP, UDP, unicast, and/or the like.

### Information Server

An information server component 516 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the DVOL controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the DVOL database 519, operating systems, other program components, user interfaces, Web browsers, and/or the like.

Access to the DVOL database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the DVOL. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the DVOL as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 517 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 518 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the DVOL enabled nodes. The combined application may be nugatory on systems employing standard Web browsers.

### Mail Server

A mail server component 521 is a stored program component that is executed by a CPU 503. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the DVOL.

Access to the DVOL mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 522 is a stored program component that is executed by a CPU 503. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POPS, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 520 is a stored program component that is executed by a CPU 503, cryptographic processor 526, cryptographic processor interface 527, cryptographic processor device 528, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the DVOL may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the DVOL component to engage in secure transactions if so desired. The cryptographic component facilitates the secure accessing of resources on the DVOL and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The DVOL Database

The DVOL database component 519 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the DVOL database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the DVOL database is implemented as a data-structure, the use of the DVOL database 519 may be integrated into another component such as the DVOL component 535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 519 includes several tables 519a-c. A market data table 519a may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi. An indices table 519b may include fields such as, but not limited to: index_ID, index_name, components, values, history, portfolio_ID, portfolio_components, portfolio_weights, portfolio_values, product_ID(s), restrictions and/or authorizations, index_profile, and/or the like. A products table 519c may include fields such as, but not limited to: product_ID, product_name, index_ID(s), terms, restrictions, transaction history, values, chain_of_title, and/or the like.

In one embodiment, the DVOL database may interact with other database systems. For example, employing a distributed database system, queries and data access by search DVOL component may treat the combination of the DVOL database, an integrated data security layer database as a single database entity.

In one embodiment, user programs may contain various user interface primitives, which may serve to update the DVOL. Also, various accounts may require custom database tables depending upon the environments and the types of clients the DVOL may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 519a-c. The DVOL may be configured to keep track of various settings, inputs, and parameters via database controllers.

The DVOL database may communicate to and/or with other components in a component collection, including itself, and/or facilities of the like. Most frequently, the DVOL database communicates with the DVOL component, other program components, and/or the like. The database may contain, retain, and provide information regarding other nodes and data.

### The DVOLs

The DVOL component 535 is a stored program component that is executed by a CPU. In one embodiment, the DVOL component incorporates any and/or all combinations of the aspects of the DVOL that was discussed in the previous figures. As such, the DVOL affects accessing, obtaining and the provision of information, services, transactions, and/or the like across various communications networks.

The DVOL component enables the determination of weights for constituents of index-linked financial portfolios, the acquisition and/or maintenance/management of those constituents, the determination of market values and/or returns associated with the indices, the generation of financial products based on the indices, and/or the like and use of the DVOL.

The DVOL component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the DVOL server employs a cryptographic server to encrypt and decrypt communications. The DVOL component may communicate to and/or with other components in a component collection, including itself, and/or facilities of the like. Most frequently, the DVOL component communicates with the DVOL database, operating systems, other program components, and/or the like. The DVOL may contain, communicate, generate, obtain, and/or provide program component, system, user, and/or data communications, requests, and/or responses.

### Distributed DVOLs

The structure and/or operation of any of the DVOL node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the DVOL controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment. The following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/c
om.ibm.IBMDI.doc/referenceguide295.htm

and other parser implementations:

http://publib.boulder.ibm.com/infocenter/tivihelp/v2r1/index.jsp?topic=/c
om.ibm.IBMDI.doc/referenceguide259.htm

all of which are hereby expressly incorporated by reference.

To address various issues related to, and improve upon, previous work, the application is directed to DEFENSIVE VOLATILITY INDEX APPARATUSES, METHODS, AND SYSTEMS. The entirety of this application (including the Cover Page, Title, Headings, Field, Background, Summary, Brief Description of the Drawings, Detailed Description, Claims, Abstract, Figures, Appendices, and any other portion of the application) shows by way of illustration various embodiments. The advantages and features disclosed are representative; they are not exhaustive or exclusive. They are presented only to assist in understanding and teaching the claimed principles. It should be understood that they are not representative of all claimed inventions. As such, certain aspects of the invention have not been discussed herein. That alternate embodiments may not have been presented for a specific portion of the invention or that further undescribed alternate embodiments may be available for a portion of the invention is not a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the invention. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functionality, features, logical aspects, organizational aspects, structural aspects, topological aspects, and other aspects of the disclosure are not to be considered limitations on the disclosure as defined by the claims or limitations on equivalents to the claims.

Depending on the particular needs and/or characteristics of a DVOL user, index underlying assets, financial product issuer, applicable market, market data source(s), index configuration, financial advisor, individual and/or enterprise user, database configuration and/or relational model, data type, data transmission and/or network framework, syntax structure, and/or the like, various embodiments of the DVOL may be implemented that enable a great deal of flexibility and customization. This disclosure discusses embodiments and/or applications of the DVOL directed to generating, managing, administrating disseminating defensive volatility indices (e.g., based on a financial index such as the S&P 500), their underlying portfolios and/or associated financial products. However, it is to be understood that the apparatuses, methods and systems discussed herein may be readily adapted and/or reconfigured for a wide variety of other applications and/or implementations. For example, aspects of the DVOL may be adapted for both and/or either long and/or short positions on variance, variances of multiple and/or foreign instruments or assets (e.g., individual stocks, currencies, precious metals, commodities, and/or the like), generating financial products with different positions with respect to variances, and/or the like. Furthermore, aspects of the DVOL may be configured to generate, administer, and/or manage a wide variety of different financial instruments, securities, and/or the like beyond specific embodiments and/or implementations described in detail herein. For example, indices discussed herein may underlie and/or be linked to any of a wide variety of financial products, derivatives, instruments, and/or the like, such as but not limited to: equities, debts, derivatives, notes (e.g., structured notes), stocks, preferred shares, bonds, treasuries, debentures, options, futures, swaps, rights, warrants, commodities, currencies, funds, long and/or short positions, ETFs, ETNs, insurance and/or risk transfer agreements, annuities, and/or other assets or investment interests. The DVOL may be further adapted to other implementations and/or investment, finance and/or risk management applications.

The invention claimed is:

1. A processor-implemented method for creating a signal-driven algorithmic defensive volatility index, the method comprising:
calculating, using an index calculator module, a signal based on the slope of a short-term portion of a volatility index futures curve and the slope of a medium-term portion of the volatility index futures curve;
determining a long position in at least one of the short-term portion and the medium-term portion of the volatility index futures curve based on the calculated signal; and
calculating a defensive volatility index value based on the at least one long position using the index calculator module.

2. The method of claim 1, wherein calculating a signal comprises calculating a first slope of the short-term portion of the volatility index futures curve, calculating a second slope of the medium-term portion of the volatility index futures curve, and calculating the difference between the first and second slopes.

3. The method of claim 2, wherein calculating the first slope of the short-term portion of the volatility index futures curve comprises subtracting the value of a one-month futures contract for the volatility index on a given day from the value of a two-month futures contract for the volatility index on the same day.

4. The method of claim 2, wherein calculating the second slope of the medium-term portion of the volatility index futures curve comprises subtracting the value of a four-month futures contract for the volatility index on a given day from the value of a seven-month futures contract for the volatility index on the same day.

5. The method of claim 1, wherein calculating a defensive volatility index value further comprises determining, based on the signal, a target weight for a short-term index portion of the defensive volatility index and a target weight for a medium-term index portion of the defensive volatility index.

6. The method of claim 5, wherein calculating a daily value for the defensive volatility index further comprises determining an actual weight for the short-term index portion by comparing the target weight for the short-term index portion to a maximum rebalance percentage and using the lesser of the target weight and the maximum rebalance percentage as the actual weight for the short-term index.

7. The method of claim 5, wherein calculating a daily value for the defensive volatility index further comprises determining an actual weight for the medium-term index portion by comparing the target weight for the medium-term index portion to a maximum rebalance percentage and using the lesser of the target weight and the maximum rebalance percentage as the actual weight for the medium-term index.

8. The method of claim 1, further comprising calculating a management fee and subtracting the management fee from the calculated defensive volatility index value.

9. The method of claim 1, further comprising calculating a trading adjustment to compensate for transaction costs and subtracting the trading adjustment from the calculated defensive volatility index value.

10. The method of claim 1, wherein the volatility index is the Chicago Board Options Exchange Market Volatility Index (VIX).

11. A system for creating a signal-driven algorithmic defensive volatility index, the system comprising:
a server having a controller running on a processor and being configured to interface with a plurality of databases to access information regarding an implied volatility index; and
an index calculator module interfacing with the controller and being configured to receive the information regarding the implied volatility index and to calculate a daily signal based on the slope of a short-term portion of the volatility index futures curve and the slope of a medium-term portion of the volatility index futures curve;
wherein the index calculator module is further configured to determine a long position in at least one of the short-term portion and the medium-term portion of the volatility index futures curve based on the calculated signal and calculate a defensive volatility index value based on the signal.

12. The system of claim 11, wherein the index calculator module is configured to calculate a first slope of the short-term portion of the volatility index futures curve, calculate a second slope of the medium-term portion of the volatility index futures curve, and calculate the difference between the first and second slopes.

13. The system of claim 12, wherein the index calculator module is further configured to calculate the first slope of the short-term portion of the volatility index futures curve by subtracting the value of a one-month futures contract for the volatility index on a given day from the value of a two-month futures contract for the volatility index on the same day.

14. The system of claim 12, wherein the index calculator module is further configured to calculate the second slope of the medium-term portion of the volatility index futures curve by subtracting the value of a four-month futures contract for the volatility index on a given day from the value of a seven-month futures contract for the volatility index on the same day.

15. The system of claim 11, wherein the index calculator module is further configured to determine, based on the signal, a target weight for a short-term index portion of the defensive volatility index and a target weight for a medium-term index portion of the defensive value volatility index.

16. The system of claim 15, wherein the index calculator module is further configured to determine an actual weight for the short-term index portion by comparing the target weight for the short-term index portion to a maximum rebalance percentage and using the lesser of the target weight and the maximum rebalance percentage as the actual weight for the short-term index portion.

17. The system of claim 15, wherein the index calculator module is further configured to determine an actual weight for the medium-term index portion by comparing the target weight for the medium-term index portion to a maximum rebalance percentage and to use the lesser of the target weight and the maximum rebalance percentage as the actual weight for the medium-term index portion.

18. The system of claim 16, wherein the index calculator module is further configured to determine an actual weight for the medium-term index portion by comparing the target weight for the medium-term index portion to a maximum rebalance percentage and to use the lesser of the target weight and the maximum rebalance percentage as the actual weight for the medium-term index portion.

19. A tangible, non-transitory processor-readable physical medium storing processor-generated instructions to:
calculate a signal based on the slope of a short-term portion of a volatility index futures curve and the slope of a medium-term portion of the volatility index futures curve;
determine a long position in at least one of the short-term portion and the medium-term portion of the volatility index futures curve based on the calculated signal; and
calculate a defensive volatility index value based on the at least one long position using the index calculator module.
